(19) United States
(12) Patent Application Publication
(10) Pub. No.: US 2013/0176817 A1
(43) Pub. Date: Jul. 11, 2013

(54) DATA ACQUISITION SYSTEM WITH REMOVABLE BATTERY HAVING INTEGRATED DATA STORAGE

(71) Applicant: WIRELESS SEISMIC, Sugar Land, TX (US)

(72) Inventor: Douglas B. Crice, Grass Valley, CA (US)

(73) Assignee: WIRELESS SEISMIC, Sugar Land, TX (US)

(21) Appl. No.: 13/715,719

(22) Filed: Dec. 14, 2012

Related U.S. Application Data
(63) Continuation of application No. 12/834,693, filed on Jul. 12, 2010, now abandoned.

(51) Int. Cl. G01V 1/24; G01V 1/16

(52) U.S. Cl. CPC G01V 1/247; G01V 1/168
USPC 367/14

(57) ABSTRACT

Data acquisition modules and systems including batteries with integrated data storage. The battery with integrated data storage can be selectively removed from the data acquisition module. This allows for reduced logistical effort associated with data retrieval and battery charging. For instance, the entire data acquisition module need not be transported to a central location for data recovery and charging, but rather the removable battery with integrated storage may be removed and transported. Also facilitated is extended surveys in that the battery or storage module may be replaced, such that survey design limitations such as storage capacity or battery life may be eliminated.

### CROSS-REFERENCE TO RELATED APPLICATION

This application is a continuation of U.S. patent application Ser. No. 12/834,693, entitled: “DATA ACQUISITION SYSTEM WITH REMOVABLE BATTERY HAVING INTEGRATED DATA STORAGE” filed on Jul. 12, 2010. The contents of the above application are incorporated by reference herein as if set forth in full.

### BACKGROUND

Seismic surveys are often used by natural resource exploration companies and other entities to create images of subsurface geologic structure. These images are used to determine the optimum places to drill for oil and gas and to plan and monitor enhanced resource recovery programs, among other applications. Seismic surveys may also be used in a variety of contexts outside of oil exploration such as, for example, locating subterranean water and planning road construction.

A seismic survey is normally conducted by placing an array of vibration sensors (accelerometers or velocity sensors called “geophones”) on the ground, typically in a line or in a grid of rectangular or other geometry. Vibrations are created either by explosives or a mechanical device such as a vibrating energy source or a weight drop. Multiple energy sources may be used for some surveys. Additionally, in many surveys the vibrations are created at regular intervals. Moreover, the energy source may be moved to various locations between the vibration events during a seismic survey. The vibrations from the energy source propagate through the earth, taking various paths, refracting and reflecting from discontinuities or “events” in the subsurface, and are detected by the array of vibration sensors. Signals from the sensors are amplified and digitized, either by separate electronics or internally in the case of “digital” sensors. The survey may also be performed passively by recording vibrations in the earth from natural or man made activities.

The digital data from a multiplicity of sensors is eventually recorded on storage media, (e.g., magnetic tape, magnetic or optical disks, or other memory device), along with related information pertaining to the survey and the energy source (e.g., a time stamp or location information). The energy source and/or the active sensors are relocated and the process continued until a multiplicity of seismic records is obtained to comprise a seismic survey. Data from the survey are processed on computers to create the desired information about subsurface geologic structure. Due to differences in propagation time associated with different geophone locations, these processes may involve correlating information received at different geophones such that the data is integrated for better event identification.

In general, as more sensors are used, placed closer together, and/or cover a wider area, the quality of the resulting image will improve. It has become common to use thousands of sensors in a seismic survey stretching over an area measured in square kilometers. Hundreds of kilometers of cables may be laid on the ground and used to connect these sensors. Large numbers of workers, motor vehicles, and helicopters are typically used to deploy and retrieve these cables. Exploration companies would generally prefer to conduct surveys with more sensors located closer together. However, additional sensors require even more cables and further raise the cost of the survey. Economic tradeoffs between the cost of the survey and the number of sensors generally demand compromises in the quality of the survey.

In addition to the logistic costs, cables create reliability problems. Besides normal wear-and-tear from handling, they are often damaged by animals, vehicles, lightning strikes, and other problems. Considerable field time is expended troubleshooting cable problems. The extra logistics effort also adds to the environmental impact of the survey, which, among other things, adds to the cost of a survey or eliminates surveys in some environmentally sensitive areas.

In response to these challenges, approaches have been proposed that eliminate the need to provide cables connecting modules. For instance, some systems employ modules that are operable to storing digitized data in a local memory at or near the sensor location. Because the data in such a system is not immediately visible to the survey crew, these systems are often referred to as “blind read out” systems. In blind read out systems, the seismic data acquired is manually read out from each module once all the seismic data has been gathered. For instance, once the survey has been completed, survey crews may physically harvest data from the modules. In many cases, the modules are gathered at the end of the seismic survey and transported to a central location for processing (e.g., data harvesting and battery charging) after the completion of the survey, or they may be harvested using some type of data collection device At the central location, each module may be processed such that data is downloaded from the module or from each data collection device Also at the central location, the modules may be connected to a charging station such that an integrated battery provided with the module may be charged. The operations of data harvesting and battery charging may be carried out simultaneously or separately.

However, such blind read out systems are undesirable, for some survey applications, as any modifications or other problems may not be detected until completion of a survey process. Furthermore, because each module stores data, each module must be transported after the survey to a location for processing. Thus, the modules are temporarily out of service while the data is downloaded from the module and the module is charged. Accordingly, substantial time, effort, and resources are dedicated to control the processing of modules after the completion of a survey prior to redeployment into a new survey area. For example, surveys may be delayed or the cost of surveys may be increased due to the unavailability of modules due to post survey processing.

### SUMMARY

Accordingly, it has been recognized that data acquisition modules that employ a removable battery with integrated data storage may facilitate solutions to the problems associated with prior systems such as those described above. In this case, a removable battery shall include a battery integral to the unit or a separate battery connected to the unit though an external connector. Furthermore, such a removable battery with integrated storage may facilitate several advantages over the prior system discussed above.

In a first respect, a removable battery with integrated data storage facilitates reduced logistical overhead as data acquisition modules employing such batteries do not need to be returned to a central location. Rather, the battery may be removed from the module and replaced (e.g., in the field) such that the data acquisition module can be immediately redeployed without the need to return each module to a central location for processing. The removed battery with integrated data storage alone can be transposed for processing, thus freeing the data acquisition module for immediate redeployment. For example, because the acquisition modules are not out of service for post acquisition data harvesting and battery charging, the need for additional modules is eliminated as modules may immediately be redeployed with a new battery with integrated data storage once the data acquisition is complete.

In a second respect, a removable battery with integrated data storage facilitates data harvesting prior to the conclusion of data acquisition. This may allow crews to troubleshoot issues identified early in the data acquisition. Thus, the time and cost of data acquisition may be reduced. Early data harvesting can be realized because a battery with integrated data storage can be removed prior to the completion of data acquisition and replaced with a new battery with integrated data storage without interrupting data acquisition. Thus, the removed battery can have data harvested from the integrated data storage while the data acquisition module continues to collect data.

In a third respect, a removable battery with integrated data storage facilitates data acquisition for a longer duration that can be realized using modules of previous systems. When designing a data acquisition scheme (e.g., a seismic survey as described above) that uses modules of previous systems, a number of variables must be considered. Among these include the desired sampling rate of collected data, the number of events to be observed, the battery life of the module, and the data storage capacity of the module. The data storage capacity and battery life of the module often limit the temporal scope of potential data acquisition (e.g., imposing a time limit related to the battery life of the modules or impose restrictions on the amount of data that can be gathered due to limits on the data storage capacity of each module). However, as a removable battery with integrated storage may be replaced in the field without interrupting the acquisition of data, the design constraints related to battery life and data storage capacity may be eliminated. Accordingly, the duration of data acquisition may be extended or increased sampling rates may be used to achieve higher data resolution resulting in the ability to collect more robust data.

In a fourth respect, a removable battery with integrated data storage facilitates a reduction in the need for logistical support in the field. For instance, the need to provide specialized equipment such as mobile data harvesting modules and battery charging modules is reduced. Rather, a battery with integrated data storage may be easily transported to and from the field with traditional means that do not require specialized equipment for remote or mobile applications, thus eliminating the need to transport the entire data acquisition module for processing. In turn, modules may be used more frequently and with shorter periods between deployments.

Further, it has been recognized that integrated data storage may be provided with minimal addition to the cost or complexity of commonly used existing batteries.

Oftentimes lithium-ion batteries are used to power data acquisition modules due to the ability of lithium-ion batteries to operate in extreme temperature ranges and because of the power density (i.e., the amount of power available per unit of battery volume) of lithium-ion batteries. As lithium-ion batteries traditionally require internal electronic modules for charge control and safety, a data storage device may be integrated into these existing electronic modules. In turn, the integration of a data storage device may add minimal cost to the battery pack.

While the discussion contained herein will primarily reference the use of a removable battery with integrated storage for a seismic data acquisition module used to conduct a seismic survey, it will be realized that other acquisition modules may realize the benefits addressed above by the use of a removable battery with integrated data storage. Accordingly, it is contemplated that such a removable battery may be utilized in various other data acquisition applications where data is stored locally at a module during acquisition and manually read out to retrieve the stored data.

In this regard, the present invention includes a first aspect that includes a data acquisition module. The module includes battery that is removable from the data acquisition module. Also, the module includes a memory operable to store acquired data. The memory is associated with the battery such that the memory is removed from the data acquisition module when the battery is removed from the data acquisition module.

A number of feature refinements and additional features are applicable to the first aspect of the present invention. These feature refinements and additional features may be used individually or in any combination. As such, each of the following features that will be discussed may be, but are not required to be, used with any other feature or combination of features of the first aspect. The following discussion is applicable to the first aspect, up to the start of the discussion of a second aspect of the present invention.

For instance, in one embodiment, the memory may be removable from the battery. Alternatively, the memory may be integral to the battery to form an integral unit. In another embodiment, the battery may be a lithium-ion battery. The battery may include an internal module for charge control, such that the internal module includes the memory. The memory and battery may be connectable to a module by way of a cable or other attachment wherein the connection is by way of a standard interface. Alternatively, the memory and battery may be directly attachable to the module such that communication is established when attached.

In one embodiment, the memory may be an electrically-erasable programmable read only memory (EEPROM). For instance, the memory may be a flash memory.

In one specific embodiment, the data acquisition module may be a seismic data acquisition module and the acquired data may be seismic data. In another embodiment, the module includes a buffer memory that is operable to temporarily store the acquired data when the memory is removed from the data acquisition module.

A second aspect of the present invention includes a data acquisition system including a data acquisition module and a docking station to which the battery may be connected for charging. The data acquisition module includes a sensor operable to acquire seismic data; a battery operable to provide power to the data acquisition module, the battery being removable from the data acquisition module; and a memory operable to store the seismic data, the memory being associated with the battery such that the memory is removed from the data acquisition module when the battery is removed from the data acquisition module. The system may further include a servicing module to which the battery is connectable for charging of the battery. When the battery is connected for charging, the memory is in operative communication with the servicing module such that the seismic data is transferred from the memory to the servicing module.

A number of feature refinements and additional features are applicable to the second aspect of the present invention. These feature refinements and additional features may be used individually or in any combination. As such, each of the following features that will be discussed may be, but are not required to be, used with any other feature or combination of features of the second aspect. The following discussion is applicable to the second aspect, up to the start of the discussion of a third aspect of the present invention.

In one embodiment, the servicing module may be adapted for simultaneous connection with a plurality of batteries simultaneously to charge the plurality of battery and transfer seismic data from a corresponding plurality of memories. The servicing module may be located remotely from a survey area into which the data acquisition module is deployed. Alternatively, the servicing module may be mobile.

A third aspect of the present invention includes a method for collecting data from a data acquisition module. The method involves removing a first battery having a first memory provided therewith from the data acquisition module. The method further includes connecting the first battery to a servicing module. The method also includes charging the first battery when the first battery is connected to the servicing module and transferring data from the first memory when the final battery is connected to the servicing module.

A number of feature refinements and additional features are applicable to the third aspect of the present invention. These feature refinements and additional features may be used individually or in any combination. As such, each of the following features that will be discussed may be, but are not required to be, used with any other feature or combination of features of the third aspect.

In one embodiment, the method may involve attaching a second battery having a second memory provided therewith to the data acquisition module. The first battery and the second battery may be the same and the first memory and the second memory may be the same. Alternatively, the first battery and the second battery may be different and the first memory and the second memory may be different.

In another embodiment, the method may further include deploying the data acquisition module into a survey field and collecting data with the data acquisition module. The deploying and collecting may occur prior to the removing step. The removing and attaching may occur while the data acquisition module is deployed in the survey field. Additionally, the removing and attaching may occur prior to the conclusion of a survey, such that the survey is not interrupted.

Any of the embodiments, arrangements, or the like discussed herein may be used (either alone or in combination with other embodiments, arrangement, or the like) with any of the disclosed aspects. Any feature disclosed herein that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that a module includes “a battery” alone does not mean that the container includes only a single battery). Moreover, any failure to use phrases such as “at least one” also does not limit the corresponding feature to the singular (e.g., indicating that a module includes “a battery” alone does not mean that the container includes only a single battery). Use of the phrase “at least generally,” “at least partially,” or the like in relation to a particular feature encompasses the corresponding characteristic and insubstantial variations thereof. Finally, a reference of a feature in conjunction with the phrase “in one embodiment” does not limit the use of the feature to a single embodiment.

### BRIEF DESCRIPTION OF THE DRAWINGS

FIG. 1 is a schematic view of one embodiment of a data acquisition module.

FIG. 2 is a schematic view depicting one embodiment of a data acquisition system.

FIG. 3 is a flow chart depicting an exemplary process for data collection using a data acquisition system.

### DETAILED DESCRIPTION OF THE DRAWINGS

While the invention is susceptible to various modifications and alternative forms, specific embodiments thereof have been shown by way of example in the drawings and are described in detail herein. It should be understood, however, that it is not intended to limit the invention to the particular form disclosed, but rather, the invention is to cover all modifications, equivalents, and alternatives falling within the scope of the invention as defined by the claims.

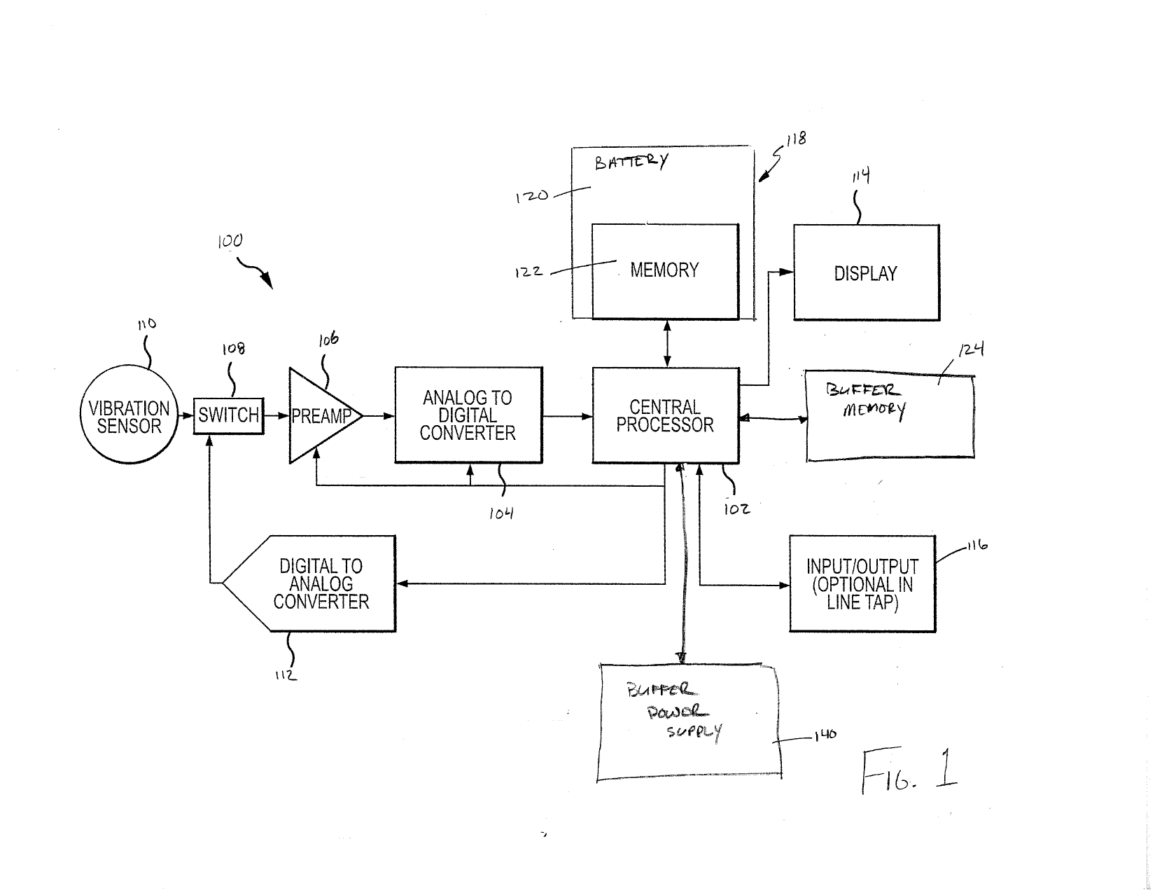

FIG. 1 is a schematic view of a data acquisition module 100. In one embodiment, the module 100 may be part of a seismic data acquisition system capable of being used to perform a seismic survey. The data acquisition module 100 may have a vibration sensor 110 that is operative to detect seismic activity. The vibration sensor 110 may be an analog sensor or a digital sensor. The vibration sensor 110 may transmit either an analog or digital signal to a switch 108, a preamplifier 106, and an analog to digital converter 104. It is to be understood that if the vibration sensor 110 is a digital sensor, the preamp 106 and the analog to digital converter 104 may not be necessary and the vibration sensor may directly transmit digital data to the central processor 102. The data acquisition module 100 may also include a GPS receiver (not shown) such that the digitized data may be appended with time and location information used for later processing.

The data acquisition module 100 may be in operative communication with an integrated module 118 that includes a memory 122 and a battery 120. The memory 122 of the integrated module 118 may be an electrically-erasable programmable read only memory (EEPROM). For instance the memory may comprise a flash memory card (e.g., a Secure Digital (SD) card, a mini SD card, micro SD card, or other similar flash memory card). In this regard, the memory may also include a microcontroller for writing or reading digital data to or from the memory 122.

The battery 120 may be a lithium-ion battery. One of skill in the art will recognize that lithium-ion batteries may include integrated circuitry to control the operation of such batteries to prevent overcharging or overheating that may lead to potentially dangerous situations. As such, in one embodiment, a memory 122 as described above may be provided as part of such integrated circuitry such that the battery 120 is permanently associated with the memory 122. Alternatively, the battery 120 may include a port to receive a separately removable memory card to form the integrated module 118.

In any regard, the integrated module 118 may connect or attach to the data acquisition module 100 such that operative communication is established between data acquisition module 100 and the memory 122 as well as between the data acquisition module 100 and the battery 120. As such, the integrated module 118 may connect to the data acquisition module through a standardized connector that provides simultaneous data and power transfer between the data acquisition module 100 and the integrated module 118 (e.g., by way of a USB connection, a Firewire connection, an RS-232 connection, or other appropriate type of connection). In this regard, in one embodiment, the integrated module 118 may include a connector (e.g., in the form of a cable or port) that interfaces with a corresponding port on the data acquisition module 100 to establish operative communication between the two modules. Alternatively, a chassis of the module 100 may correspond to a chassis of the integrated module 118 such that the two are directly attachable (e.g., by way of a snap fit or other structure to physically attach the two modules) to each other. In this regard, contacts may be provided on the respective housings that allow for power and data connections between the integrated module 118 and the data acquisition module 100 to be established. In any regard, the connection or attachment of the integrated module 118 and the data acquisition module 100 may be established in such a manner that is impervious to environmental conditions (e.g., rain, snow, dust, mud, etc.) or other adverse conditions encountered in the field.

In any regard, when the integrated module 118 is in operative communication with the module 100, the battery 120 may be operative to supply power to the various components of the module 100 and the memory 122 may be in operative communication with the central processor 102. As such, the battery 120 may power the module 100 and digitized seismic data may be stored in the memory 122 when the integrated module is in operative communication with the data acquisition module 100.

For ease of discussion, integrated modules 118 may be referred to herein as “fresh” or “expended.” It will be understood that by a fresh integrated module, it is meant that the integrated module includes on at least partially charged battery and a memory that has some capacity for data storage. It does not require that the battery be fully charged or that the memory be empty, although this may be the case. Additionally, reference to an expended integrated module 118 means that at least some of the charge of the battery has been used and that at least some data has been written to the memory of the integrated module. An expended integrated module does not necessarily require that the battery completely depleted or the memory be full, although this may be the case.

As stated above, the integrated module 118 may be selectively removed from the data acquisition module 100. In this regard, a buffer power supply 140 may also be provided with the data acquisition module 100. The buffer power supply 140 may provide a temporary source of power to the data acquisition module 100, such that when a expended integrated module 118 is removed from the data acquisition module 100, the buffer power supply 140 may provide an adequate supply of power to the data acquisition module 100 such that it may temporarily continue operation without interruption.

In the same regard, when an expended integrated module 118 is removed from the data acquisition module 100, data can no longer be stored on the memory 122. In turn, the central processor 102 may be operative to store digitized seismic data in a buffer memory 124. The buffer memory 124 may be operative to temporarily store digitized data while the expended integrated module 118 is detached from the data acquisition module 100. Accordingly, seismic data from the vibration sensor 110 may continue to be gathered and written into the buffer memory 124 using power supplied by the buffer power supply 140 when the expended integrated module 118 is removed from the data acquisition module 100. The buffer power supply 140 and buffer memory 124 may each be appropriately sized such that both are capable of performing their respective tasks for a limited duration (e.g., long enough for an expended integrated module 118 to be removed and replaced by a fresh integrated module 118).

Once a fresh integrated module 118 has been connected to the data acquisition module 100, the central processor 102 may transfer any data temporarily stored on the buffer memory 124 to the memory 122 of the fresh integrated module 118 while also maintaining the continual transfer of data collected in real time. Additionally, the battery 120 of the fresh integrated module 118 may be operative to replenish any charge depleted from the buffer power supply 140 during the replacement of the expended integrated module 118.

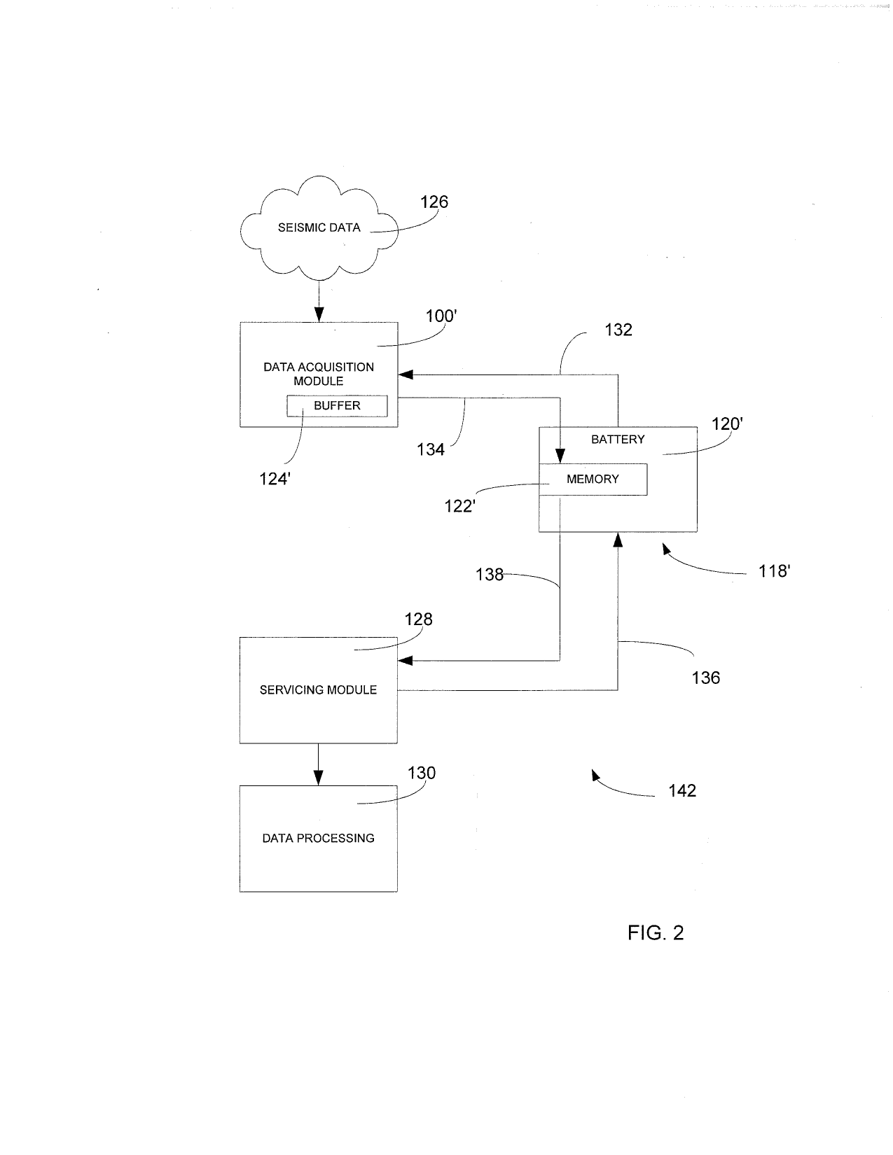

Turning to FIG. 2, a schematic view of a data acquisition system 142 is depicted. The data acquisition system 142 may include similar components as those discussed above with regard to FIG. 1. Accordingly, corresponding components between FIG. 1 and FIG. 2 will be referenced using common reference numerals. Accordingly, the discussion above regarding the components of FIG. 1 is equally applicable to the corresponding components shown in FIG. 2.

In this regard, the data acquisition system 142 may include a data acquisition module 100 with a buffer memory 124. Additionally provided may be an integrated module 118 comprising a battery 120 and a memory 122. The integrated module 118 may allow for incoming data 134 from the data acquisition module 100 to be written to the memory 122 when the integrated module 118 is connected to the data acquisition module 100. Additionally, the battery 120 may provide power 132 to the data acquisition module 100 when the integrated module 118 is connected. In this regard, seismic data 126 may be digitized by the data acquisition module 100, transferred in the form of incoming data 134 to the integrated module 118, and written into memory 122 when the integrated module 118 is connected to the module 100. Also as discussed above with regard to FIG. 1, a buffer memory 124 may be provided such that when an expended integrated module 118 is removed from the data acquisition module 100, the buffer 124 may be operative to temporarily store digitized seismic data 126 and transfer the temporarily stored data to a memory 122 once connected to a fresh integrated module 118.

Once an expended integrated module 118 has been removed from the data acquisition module 100, the integrated module 118 may be operatively connected to a servicing module 128. While the integrated module 118 of FIG. 2 is schematically depicted as being operative to communicate with both the data acquisition module 100 and the servicing module 128, it will be understood that the integrated module 118 may be connected to only one of the data acquisition module 100 or the servicing module 128 at a time.

When connected to the servicing module 128, the integrated module 118 may be operative to transfer outgoing data 138 from the memory 122 to the servicing module 128. Additionally, when the integrated module 118 is connected to the servicing module 128, the servicing module 128 may provide charging power 136 to the battery 120. In this regard, an expended integrated module 118 may be connected to the servicing module 128 such that once processed (e.g., once data is transferred from the memory 122 and the charge of the battery 124 is replenished) the integrated module 118 may be disconnected and ready for use as a fresh integrated module 118.

While in FIG. 2, a single integrated module 118 is shown in operative communication with the servicing module 128 to transfer data thereto and receive charging power therefrom, it will be additionally understood that a plurality of similar integrated modules 118 may be provided in operative communication with the servicing module 128. In this regard, the servicing module 128 may take the form of a rack that receives a plurality of integrated modules 118 such that when the integrated modules 118 are received by the servicing module 128, the integrated module 118 may transfer data from a memory 122 to the servicing module and may receive charging power 136 therefrom. Furthermore, in one embodiment where the memory 122 is separately removable from the battery 120, the servicing module 128 may provide for separate data transfer from the memory 122 and charging of the battery 120.

The servicing module 128 may be in operative communication with data processor 130 in order to process the acquired seismic data. For instance, the data processor 130 may be operative to correlate data recovered from a plurality of modules 100 to produce a representation of the survey area from the collected seismic data.

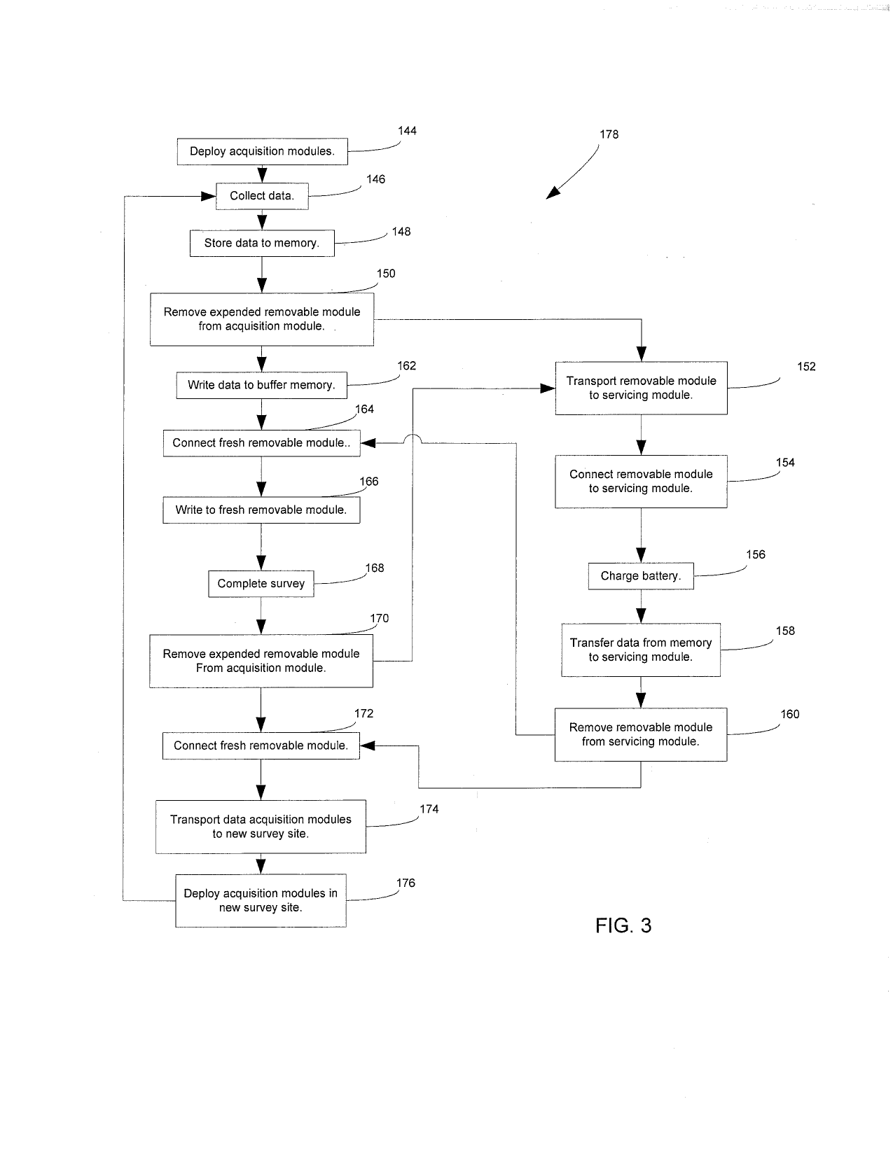

With reference to FIG. 3, a process 178 for use with a data acquisition system is shown. The process 178 may include deploying (144) acquisition modules into a survey area. The deploying (144) may further include designing a survey. In this regard, survey parameters and objectives may be gathered and analyzed to determine the number, spacing, or other parameters regarding the survey. Once the survey has been designed, the deploying (144) may include physical deployment of at least one data acquisition module into the field. The data acquisition module may collect (146) data (e.g., seismic data associated with the seismic survey). The data collection (146) may include digitizing an analog signal or processing data directly from a digital sensor that is in turn ready for storage. In any regard, the module may store (148) data to a memory of an integrated module.

During the survey (i.e., prior to the conclusion of the survey), an expended integrated module may be removed (150) from the acquisition module. Once removed (150) from the data acquisition module, the expended integrated module may be transported (152) to a servicing module. The servicing module may be located in the field near the seismic survey site (e.g., the servicing module may be mobile) or may be at a central location. The integrated module may be connected (154) to the servicing module. Upon connection, the servicing module may be operative to charge (156) the battery of the integrated module and transfer (158) data from the memory of the integrated module to the servicing module. The integrated module may, in turn, be removed (160) from the servicing module. As such, when removed (160), the integrated module may be a fresh integrated module ready for use with a data acquisition module.

While the expended integrated module is removed from the acquisition module, the acquisition module may write (162) data to a buffer memory. When a fresh integrated module is connected (164), data may be written (166) into the integrated module. The writing (166) may include transferring the data written (162) to the buffer memory to the memory of the fresh integrated module as well as transfer of data being gathered in real time by the acquisition module after the replacement (162) of the integrated module. Data may be written (166) to the integrated module until the survey is completed (168).

Upon completion (168) of the survey the spent integrated module 118 may be removed (170) from the data acquisition module and undergo steps 152-160 as described above. Additionally, a fresh integrated module may be connected (172) to the data acquisition modules. The data acquisition module may be transported (174) to a new survey site and deployed (176) within the new survey site such that the process 178 may repeat and data may again be collected (146). In turn, the data acquisition modules may be continually deployed into a survey area as facilitated by continual replacement of expended integrated modules as batteries are depleted and memories are filled with data.

In one embodiment of the process 178, the removal (150) of a spent integrated module, writing (162) to the buffer memory, and replacement (162) with a fresh integrated module may take place in a relatively short time span such that the survey may continues uninterrupted (e.g., as facilitated by buffer memory and buffer power supply as discussed above). In turn, the duration of the survey may be extended beyond the duration of a normal survey employing modules that require removal from the field for processing. Furthermore, the removal (150) of expended integrated modules prior to the completion (168) of the survey may allow for early data read outs from the modules so that any potential problems associated with the survey can be identified and addressed prior to the completion (168). Further still, the removal (170) of expended integrated modules before transporting (174) data acquisition modules to a new survey site prevents the need to transport the entire acquisition module to a central location. In turn, only the integrated modules need to be transported to a servicing module. This may significantly reduces logistical needs because the integrated modules may be easier transport and may, in fact, may be easily serviced by a servicing module in the field. Additionally, as the acquisition modules may be redeployed (176) without the need to return the acquisition modules to a central location for data transfer and battery charging, the data acquisition modules may be redeployed (176) faster than tradition data acquisition modules that are required transportation to a central location for data transfer and battery charging.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

1.-13. (canceled)

14. A method of collecting data from a data acquisition module, comprising:
removing a first battery having a first memory provided therewith from the data acquisition module;
connecting the first battery to a servicing module;
charging the first battery when the first battery is connected to the servicing module; and
transferring data from the first memory when the first battery is connected to the servicing module.

15. The method of claim 14, further comprising:
attaching a second battery having a second memory provided therewith to the data acquisition module.

16. The method of claim 15, wherein the first battery and the second battery are the same and the first memory and the second memory are the same.

17. The method of claim 15, wherein the first battery and the second battery are different and the first memory and the second memory are different.

18. The method of claim 15, further comprising:
deploying the data acquisition module into a survey field;
collecting data with the data acquisition module;
wherein the deploying and collecting occur prior to the removing step.

19. The method of claim 19, wherein the removing and attaching occur while the data acquisition module is deployed in the survey field.

20. The method of claim 19, wherein said removing and attaching occur prior to the conclusion of a survey, and wherein the survey is not interrupted.

21. The method of claim 18, further comprising:
transporting the first battery and the first memory to a data processing facility; and
relocating the data acquisition module to a different survey field after the removing;
wherein the data processing facility is remote from both the survey fields.

22. A method for deployment of seismic data acquisition modules for conducting a seismic survey, comprising:
deploying at least one seismic data acquisition module in a first survey area;
acquiring seismic data using the seismic data acquisition module;
storing the seismic data in a memory, wherein the memory comprises an integrated module including a battery such that the memory is removed from the data acquisition module when the battery is removed from the data acquisition module;
removing the memory and the battery from the seismic data acquisition module after the storing;
transporting the memory and the battery to a data processing facility; and
relocating the seismic data acquisition module to a second survey area;
wherein the data processing facility is remote from the first survey area and the second survey area.

23. The method of claim 22, wherein the relocating includes moving the seismic data acquisition module directly from the first survey area to the second survey area.

24. The method of claim 23, further comprising:
attaching a second integrated module comprising a second memory and a second battery to the seismic data acquisition module prior to deployment in the second survey area.

25. The method of claim 24, wherein the second integrated module is sent from the data processing facility to the second survey area.

26. The method of claim 22, wherein the integrated module is processed at the data processing facility including reading the seismic data from the memory and charging the battery; wherein the reading and charging are performed substantially simultaneously at a servicing module.

27. The method of claim 26, wherein the servicing module is operable for deleting the seismic data from the memory after the reading, wherein after the deleting, the integrated module is ready for sending to another survey area.
